(19) United States
(12) Patent Application Publication
(10) Pub. No.: US 2005/0010559 A1
(43) Pub. Date: Jan. 13, 2005

(54) Methods for information search and citation search

(76) Inventors: Joseph Du, Hsin-Tien City (TW); Hsien-Ying Tseng, Tainan (TW); Shih-Wen Tu, Taipei (TW); Chia-Hui Lin, Hsin-Chu (TW); Dah-Chih Lin, Hsin-Chu (TW); Chun Yi Chen, Jian Township (TW); Jeffrey Liou, Hsin-Chu City (TW); Yueh-Ching Lee, Jhongli City (TW); Ted Chiang, Dari Tachung (TW)

Correspondence Address: DUANE MORRIS, LLP;IP DEPARTMENT, ONE LIBERTY PLACE, PHILADELPHIA, PA, 19103-7396, US

(21) Appl. No.: 10/618,486

(22) Filed: Jul. 10, 2003

(51) Int. Cl. G06F 7/00

(52) U.S. Cl. 707/3

(57) ABSTRACT

A computer-based information search method comprises the steps of: receiving a search query, the search query comprising at least one term; receiving a network resource list, the list comprising at least one web site selected from a predetermined web site list; semantically analyzing the search query; and searching the network resource list for a response to the search query using a search engine. A computer-based citation search method comprises the steps of: receiving a search query, the search query comprising an patent identification condition; receiving a list of patent databases; searching the list of patent databases to collect at least one reference patent that cites patents or is cited by patents satisfying the condition of the search query; and producing a citation list, the list comprising at least an owner of the reference patent.

### FIELD OF THE INVENTION

The present invention relates to software generally, and more specifically to an information search method and system.

### BACKGROUND

Information is generated and accumulated at an astonishing speed. A method of effectively searching information related to a specific subject is a necessary means to resolve real-life problems. Many commercial search engines such as Google provide the function of searching internet web sites for a string of words through indexes created by their own proprietary algorithms.

A search engine is a program that searches documents in web sites for specified keywords and returns a list of documents where keywords were found. Typically, a search engine works by sending out spiders to automatically fetch documents in web sites and feed back to the search engine. It is called a spider because it “crawls” over the web. The search engine then reads these documents and creates indexes based on its proprietary algorithm. Due to inherit limitation of the proprietary algorithms employed by search engines, some related web sites may be neglected. After receiving a query, the search engine in fact searches the indexes rather than going out to direct search web sites again. As a result, some search results are not the latest information, although spiders periodically send back information to update indexes. In addition, concurrently searching a plurality of databases is available in the prior art.

Patents are an important portion of information that people in many industries would like to search. Patents usually cite other patents in the same or similar technology fields that are published earlier as prior art. Thus, the relationship among patents that cite or are cited by other patents indicates a certain degree of relevance among those patents. The identification of cited patents such as patent number is generally included in a patent document. Through the citation list in patent documents, a citation search is available to provide an indication among patents. For example, published United States patents have a field of “reference cited” listing other related patents as prior art. In the web site of the United States Patent and Trademark Office, the function of a basic citation search is provided.

### SUMMARY OF THE INVENTION

A computer-based information search method comprises the steps of: receiving at least a search query, the search query comprising at least one term; receiving a network resource list, the list comprising at least one web site selected from a predetermined web site list; semantically analyzing the search query; and searching the network resource list for a response to the search query using a search engine. A computer-based citation search method comprises the steps of: receiving a search query, the search query comprising at least one patent identification condition; receiving a list of patent databases, the list comprising at least one patent database; searching the list of patent databases to collect at least one reference patent that cites patents or is cited by patents satisfying the condition of the search query; and producing a citation list, the list comprising at least an owner of the reference patent.

### BRIEF DESCRIPTION OF THE DRAWINGS

FIG. 1 is a block diagram of a system including an exemplary information search method.

FIG. 2 is a flow chart diagram of an information search method.

FIG. 3 is a flow chart diagram of another embodiment of the information search method including more features.

FIG. 4 is a flow chart diagram of a citation search method.

FIG. 5 is a flow chart diagram of another embodiment of the citation search method including more features.

FIG. 6 is a flow chart diagram of a process to obtain additional names for citation searches.

FIG. 7 is a flow chart diagram of another embodiment of the citation search method to search for second tier reference patents.

FIG. 8 is a flow chart diagram of another embodiment of the citation search method including the function of watch list and notice.

FIG. 9 is a diagram of an exemplary predetermined web site list categorized by technologies.

### DETAILED DESCRIPTION

An exemplary embodiment of the present invention provides an efficient computer-based information search method and/or citation search method.

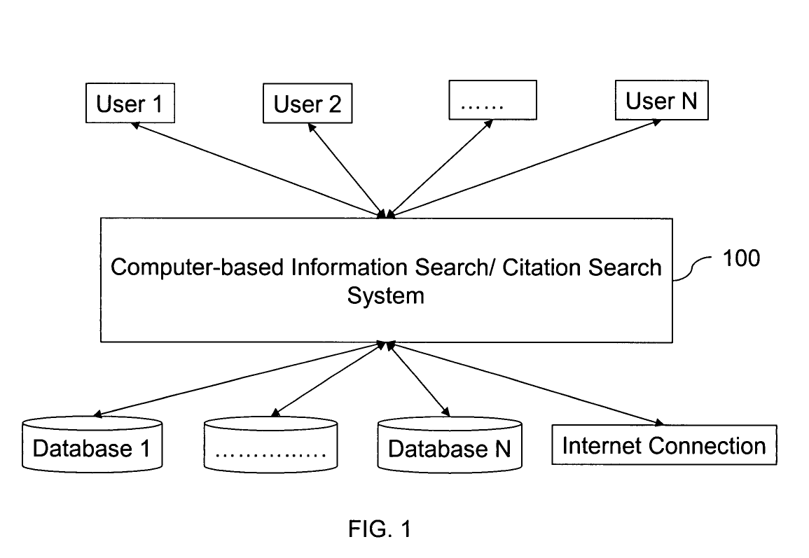

FIG. 1 is a block diagram of an exemplary system 100 implementing a computer-based information search method/citation search method according to one embodiment of the present invention. Through system 100, network resources such as databases and internet websites are searched for information and/or for patent citations. The Databases can be, but are not limited, journal databases, patent databases, or the like.

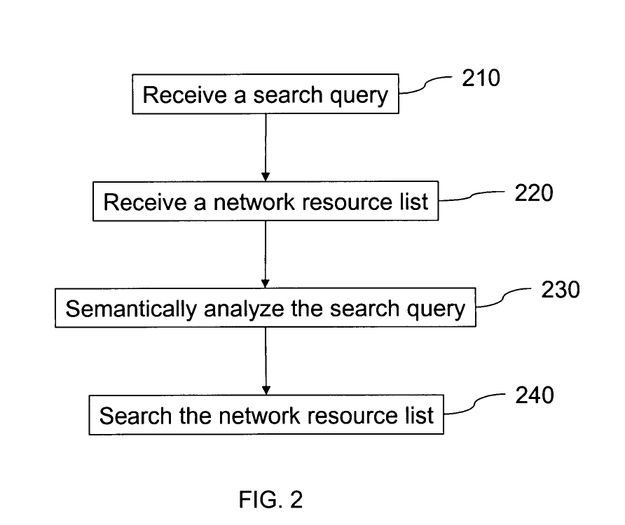

FIG. 2 is a flow chart of the process performed in the computer-based information search method. At step 210, a search query is received. The search query contains at least one condition. The condition can be publication before or after a specific date, or during a specific period of time. The condition can also be inclusion of a word, a phrase, a sentence, a paragraph, or an article. For example, a search query comprises two conditions with the first condition being a phrase as “chemical vapor deposition” and the second condition being a date “before 1 Jan. 2003.” More than one conditions can be combined using various Boolean operators such as AND, OR, and NOT. The question mark (?) or other wildcard character can also be used for truncation.

In a computer-implemented system, the step 210 is performed by a search-query receiving means that receives at least one search condition. The search-query receiving means can be a processor programmed to receive a search condition. The program can be written in any kind of computer language such as Java, C, C⁺⁺, Visual C, Visual Basic, or Assembly. Various input devices that can be used to pass the data to the processor can include but are not limited to a keyboard, a mouse, a touch-screen, a writing recognition device, a voice recognition device, a storage medium reading device, a network connection, or the like.

At step 220, a network resource list is received. The network resource list comprises at least one web site selected from a predetermined web site list. A user can request to search at least one specific web site in addition to a routine search conducted by a search engine which indexes web site information by its own proprietary algorithm. Consequently, search results with high relevance can be attained because the user may have better knowledge about which web sites may contain more related information relevant to a specific search. In addition, by directly searching user-specified web sites, the most updated search result can be obtained from these web sites, compared with the search conducted by the search engine. Because the search engine searches indexes created by itself (rather than directly searching web sites) to find related web sites, and because the indexes are only updated once in a while from the information sent back by spiders, the search result from the search engine can be outdated.

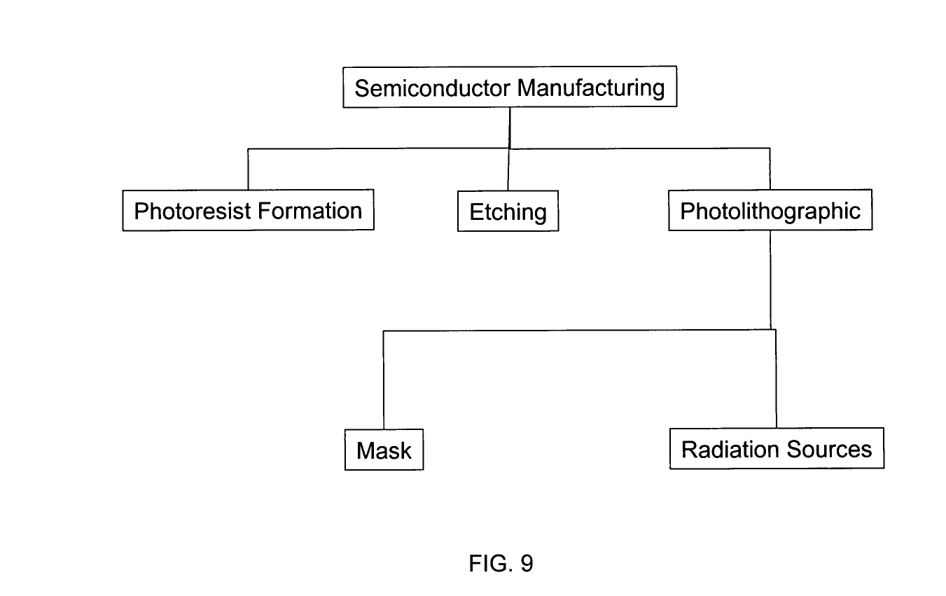

In some embodiments, the predetermined web site list from which the user can specify at least one web site to search is categorized by technologies. A tree structure is used to form technology categorization. For example, in FIG. 9, a category of semiconductor manufacturing is divided into sub-categories of photoresist formation, etching, and photolithography. The sub-category of photolithography is further divided into subjects of mask and radiation resources. Web sites are listed under related technology categories for the user to choose and request a direct search on these specific web sites. If the user does not find the web sites he thinks are more related to a specific technical topic that he wants to search, the user can add the desired web sites to the predetermined web site list under an appropriate technology category. Consequently, search know-how of experienced users can be accumulated in the predetermined web site list. A new user can find out and request a search on more related web sites from the technology categorized web site list.

In addition to the specified web sites, the user can also request to search some specific databases and other network resources. For example, a U.S. patent database and a database of IEEE published papers can be searched.

In a computer-implemented system, the step 220 is performed by a network-resource-list receiving means that receives a list of web sites and/or databases. The network-resource-list receiving means can be a processor programmed to receive a list of web sites and/or databases. The program can be written in any kind of computer language such as Java, C, C⁺⁺, Visual C, Visual Basic, or Assembly. Various input devices that can be used to pass the data to the processor can include but are not limited to a keyboard, a mouse, a touch-screen, a writing recognition device, a voice recognition device, a storage medium reading device, a network connection, or the like.

At step 230, the search query is semantically analyzed before the search is conducted. When the search query contains more than one word, a semantic analysis is undertaken to obtain relations between words used in a phrase, a sentence, a paragraph, or an article as a guidance for the search conducted thereafter. Several commercial products, such as PolyAnalyst from Megaputer, Knowledgist from Knowledge Management Connection Corporation, TextAnalyst, Hunter-Gatherer, Semantic Web, or Ontologies, can be incorporated to perform semantic analysis.

In a computer-implemented system, the step 230 is performed by a semantic analysis means that analyzes the search query. The semantic analysis means can be a processor programmed to analyze the search query. The program can be written in any kind of computer language such as Java, C, C⁺⁺, Visual C, Visual Basic, or Assembly.

At step 240, searching the network resource list for a response to the search query is conducted by using a search engine. The search engine searches specified databases and web sites listed on the network resource list, in addition to a routine web site search conducted through the proprietary algorithm of the search engine. In some embodiments, searches are conducted at a pre-scheduled time. Several commercial products of a search engine, such as Field Search Management from Empolis, Freesearcher, KMS from Intumit Technology Corporation, Yahoo, Google, or Altavista can be employed to perform the network resource searching. A combined search result is then presented to the user.

In a computer-implemented system, the step 240 is performed by a search means that searches the web sites and/or databases on the list received. The search means can be a processor programmed to search the web sites and/or databases. The program can be written in any kind of computer language such as Java, C, C⁺⁺, Visual C, Visual Basic, or Assembly.

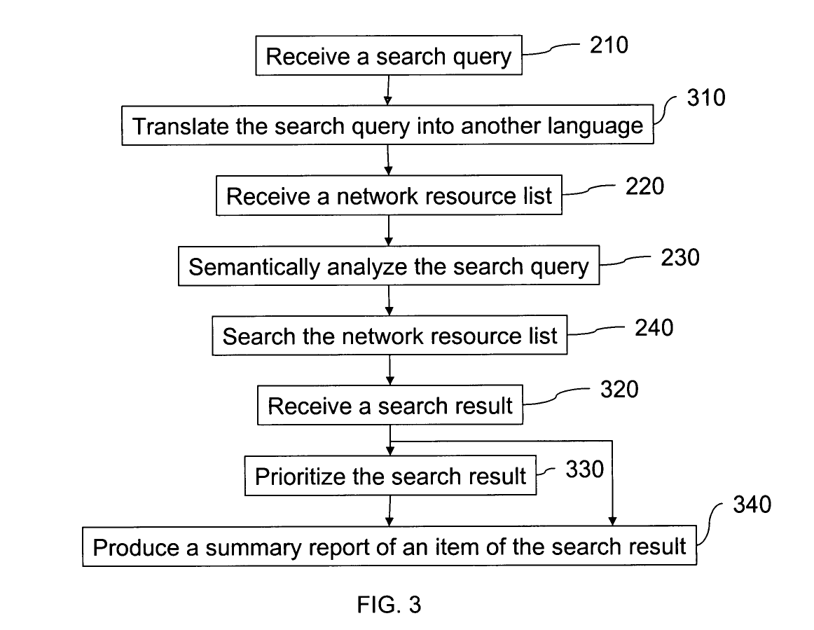

FIG. 3 is a flow chart of another embodiment of the information search method containing more features besides processes shown in the FIG. 2. At step 310, the search query received is translated into a language different from the language in which the search query is written for the purpose of searching network resources for documents written in that language. Although English has been the most widely used language, information written in many other languages is sometimes needed. Thus, a translation of the search query is provided to obtain a more complete search result. For example, when a search query of “positive photoresist” is received, it is translated into Japanese and the corresponding translation is used to search the network resource list. An electronic dictionary can be employed to translate the search query. The translation is conducted after receiving the search query and before searching the network resource list. In the embodiment shown in FIG. 3, the translation is conducted before receiving a network resource list. In other embodiments, the sequence of performance can be different. Several commercial products, such as Catalyst from Alchemy Software Development, Batam from Alis Technologies, Convey Localization Suite, KMS from Intumit Technology Corporation, GlobalSight System 4 from GlobalSight, WebGlobalization from Skandis Systems, can be incorporated to perform the translation.

In a computer-implemented system, the step 310 is performed by a translation means that translates the search query into another language. The translation means can be a processor programmed to receive a search condition. The program can be written in any kind of computer language such as Java, C, C⁺⁺, Visual C, Visual Basic, or Assembly.

At step 330, after receiving search results from the search engine, in some embodiments, the search result is prioritized by an attribute selected by a user. For example, the search result can be prioritized by the date each documents was generated. The search result can be prioritized simply by the level of word-for-word matching with the search query. The search result can also be prioritized for the relevance with the search query using subject-action-object analysis.

At step 340, a summary report of an item of the search result is produced. The search results may contain a long article or patent that consumes tremendous amount of time to read. The article or patent can be summarized. Accordingly, the user can quickly catch the gist of the article or the patent and decide whether he/she wants to read more contents about the article or patent. Many algorithms can be used to produce the summary report. For example, the summary report is generated by using subject-action-object analysis. Several commercial products, such as KMS from Intumit Technology Corporation, can be employed to produce summary reports.

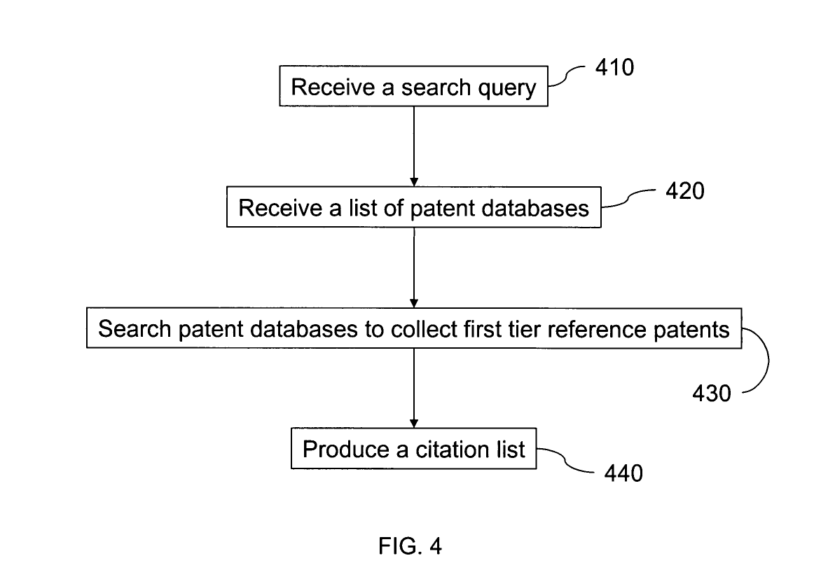

In FIG. 4, a flow chart demonstrates processes of a computer-based citation search method. At step 410, a search query is received. The search query contains conditions to identify patents. For example, one search query contains conditions of “issued after 1 Jan. 2002” and “assignee being IBM.” In another example, the condition of the search query can be that the assignee of patents is an employer of a user. More than one conditions can be combined using various Boolean operators such as AND, OR, and NOT. The question mark (?) or other wildcard character can also be used for truncation.

At step 420, a list of patent databases is received. More than one database can be specified. The patent databases can include issued patents and published patent applications. The patent databases can be United States patent database, Japanese patent database, or European patent database. When a different language is required to search a specified patent database, the search query is translated into that language for conducting the search.

At step 430, patent databases are searched to collect first tier reference patents that cite or are cited by patents satisfying conditions of the search query. Using the aforementioned search query, for example, the first tier reference patents are patents that cite or are cited by IBM's patents issued after 1 Jan. 2002. In other words, the first tier reference patents are patens having forward citation relationship or backward citation relationship with IBM's patents issued after 1 Jan. 2002.

At step 440, a citation list is produced. In one embodiment, the citation list comprises owners, patent numbers, titles, and issued dates of the first tier reference patents. In some embodiments, patents commonly owned by a single entity are identified in the citation list even if those patents specify different names of assignee. Various statistical functions such as summation can be performed while producing the citation list. For example, a citation list of first tier reference patents citing IBM's patents issued after 1 Jan. 2002 can be first sorted by owners and further sorted by issued dates.

In a computer-implemented system, the step 410 is performed by a search query receiving means to receive at least one search condition. The step 420 is performed by a patent-database-list receiving means to receive a list of patent databases. The step 430 is performed by patent-database searching means to collect first tier reference patents. The step 440 is performed by citation-list producing means to produce citation list. These means can be a processor programmed to appropriately perform specific functions. The program can be written in any kind of computer language such as Java, C, C⁺⁺, Visual C, Visual Basic, or Assembly.

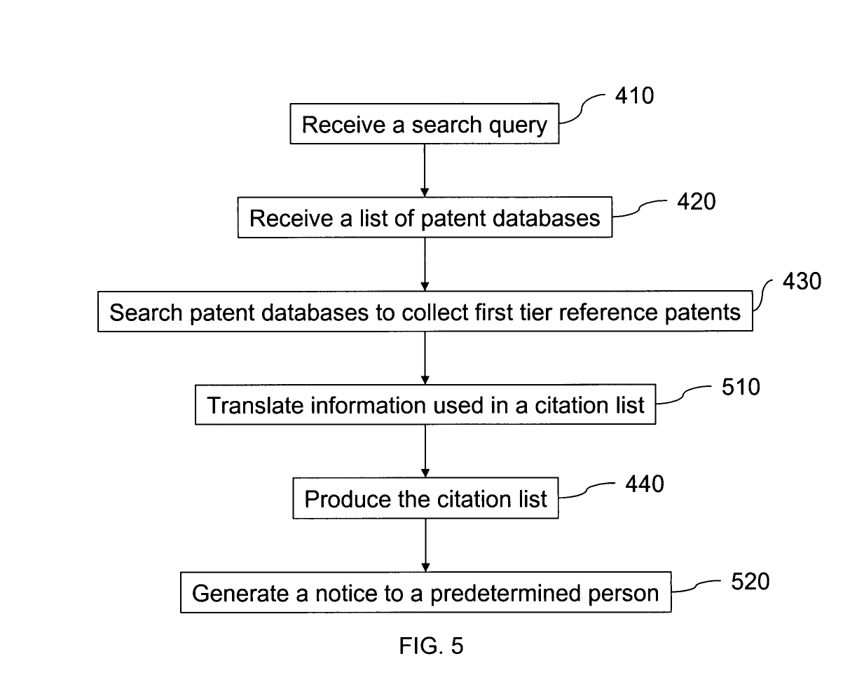

FIG. 5 is a flow chart of another embodiment of the citation search method. At step 510, when a citation search is conducted in patent databases of countries using different languages, the first tier reference patents may be located in patent databases of different languages. When this occurs, information used to produce the citation list, such as names of owners, titles of patents, is translated. For example, when the Japanese patent database is also specified for citation search, owners' names of the Japanese first tier reference patents need to be translated to produce the citation list.

At step 520, a notice is generated to a predetermined person when the owner of the first tier reference patents matches a predetermined entity. For example, if the predetermined entity is Intel, a notice is generated to a manager when the owner of at least one first tier reference patents is Intel. Taking the example of the search query of IBM's patents issued after 1 Jan. 2002, a notice is generated if at least one Intel patent cites or is cited by IBM's patents issued after 1 Jan. 2002. In some embodiments, the notice is automatically generated by the system and sent to the predetermined person by e-mail.

In a computer-implemented system, the step 520 is performed by a notice generating means that generates a notice to a predetermined person. The notice generating means can be a processor programmed to generate a notice. The program can be written in any kind of computer language such as Java, C, C⁺⁺, Visual C, Visual Basic, or Assembly. In some embodiments, the notice can be an electronic mail automatically generated by the system and sent to the predetermined person. In other embodiments, the notice can be a fax or a phone call automatically generated by the system.

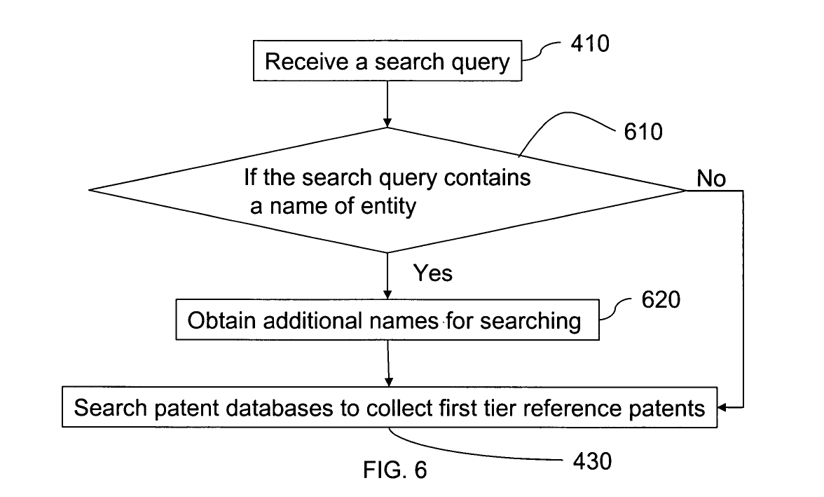

FIG. 6 illustrates a flow chart of a process to obtain additional names for a citation search when the search query contains a name of an entity. After receiving a search query at step 410, a decision regarding whether the search query contains a name of an entity is made at step 610. If yes, at step 620, additional names associated with that entity are obtained for citation searching. The same entity may possibly be listed as an assignee in patents by different names. For example, IBM and International Business Machine Corporation represent the same entity. But in some patents IBM is used, and in some other patents International Business Machine Corporation is used. In order to have an accurate citation search, it is necessary to obtain additional names used by the same entity in the assignee field of patents. In one embodiment, additional names are obtained by referring to an entity name table that contains additional names of entities. When one of the names is entered, the system automatically queries the database for records containing any of the additional names for that entity. In a computer-implemented system, a means, such as a programmed processor, is employed to perform the function.

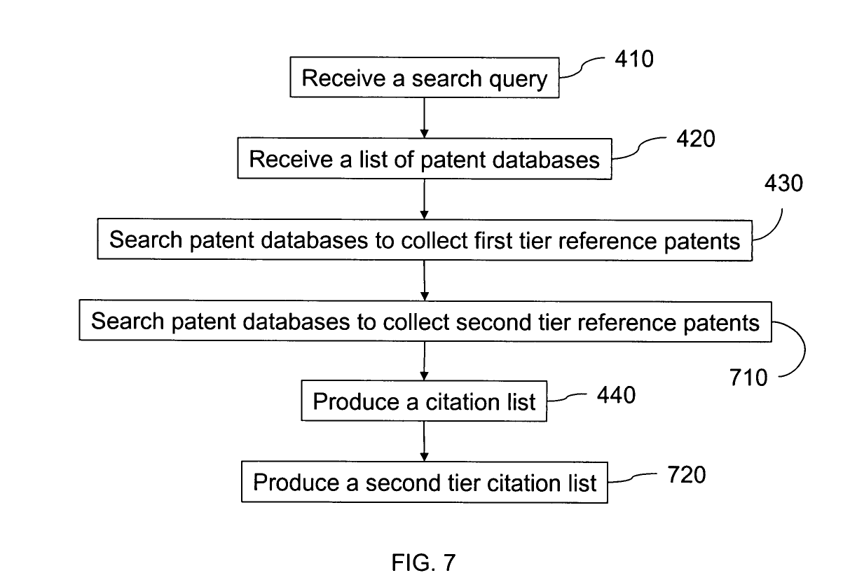

FIG. 7 is a flow chart of another embodiment of a citation search method. At step 710, patent databases are searched again to locate second tier reference patents after first tier reference patents are obtained. Second tier reference patents are patents that cite or are cited by first tier reference patents. Second tier reference patents are still to a certain extent related to patents specified in conditions of the search query. The search for second tier reference patents is conducted after obtaining first tier reference patents and before producing a second tier citation list.

At step 720, a second tier citation list is produced. In one embodiment, the second tier citation list comprises owners, patent numbers, titles, and issued dates of the second tier reference patents. Various statistical functions such as summation can be performed while producing the second tier citation list.

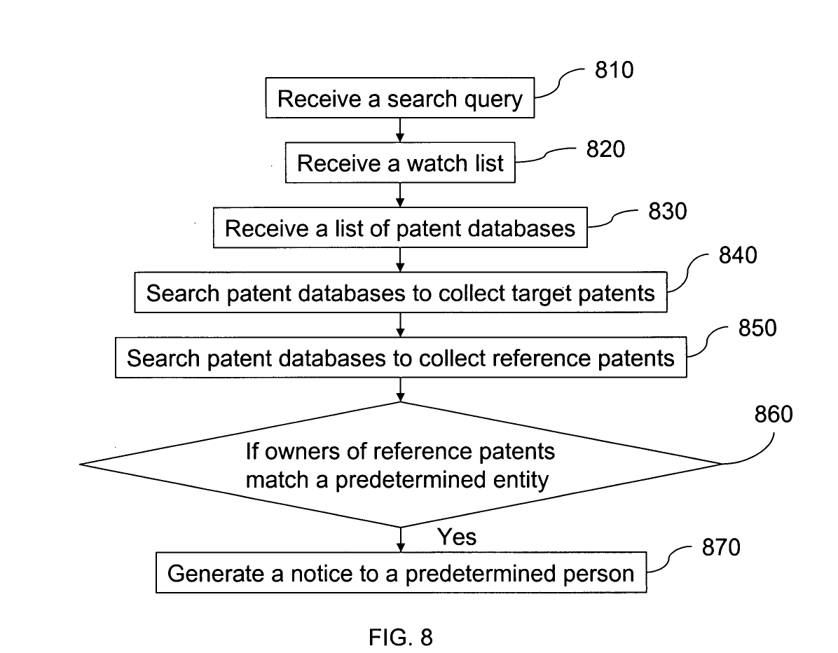

FIG. 8 is a flow chart of another embodiment of a citation search. At step 810, a search query is received. The search query contains conditions to identify patents. For example, the search query may request patents issued from 1 Jan. 2002 to 1 Jan. 2003. At step 820, a watch list comprising names of entities is received. For example, the watch list may contain General Motors and Honda. At step 830, a list of databases is received. For example, the databases may include United States patent databases. At step 840, patent databases are searched to collect target patents both satisfying conditions of the search query and whose owners match at least one entity set forth in the watch list. Taking the same example, U.S. patents issued to General Motors or Honda from 1 Jan. 2002 to 1 Jan. 2003 are located as target patents. At step 850, patent databases are searched again to collect reference patents that are cited by target patents. In the same example, patents that are cited by U.S. patents issued to General Motors or Honda from 1 Jan. 2002 to 1 Jan. 2003 are collected as reference patents. At step 860, a decision is made regarding whether owners of the reference patents matches a predetermined entity. For example, the predetermined entity may be Ford. At step 860, if yes, a notice is generated to a predetermined person. In some embodiments, the notice is automatically generated by the system and sent to the predetermined person by e-mail. Taking the same example, if any owner of patents that are cited by U.S. patents issued to General Motors or Honda from 1 Jan. 2002 to 1 Jan. 2003 is Ford, a notice is generated to a predetermined person, such as a manager. In other words, if any U.S. patents issued from 1 Jan. 2002 to 1 Jan. 2003 and assigned to General Motors or Honda cite Ford's patent, a notice is generated to a manager.

In a computer-implemented system incorporating processes shown in FIG. 8, a search-query receiving means, a watch-list receiving means, a patent-database-list receiving means, a patent-database searching means, and a notice generating means can be a processor programmed to perform the required functions. The program can be written in any kind of computer language such as Java, C, C⁺⁺, Visual C, Visual Basic, or Assembly.

The present invention may be embodied in the form of computer-implemented processes and apparatus for practicing those processes. The present invention may also be embodied in the form of computer program code embodied in tangible media, such as floppy diskettes, read only memories (ROMs), CD-ROMs, hard disk drives, high density (e.g., ZIP™) diskettes, electrically erasable programmable ROM (EEPROM), flash memory, or any other computer-readable storage medium, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over the electrical wiring or cabling, through fiber optics, or via electromagnetic radiation, wherein, when the computer program code is loaded into and executed by a computer, the computer becomes an apparatus for practicing the invention. When implemented on a general-purpose processor, the computer program code segments configure the processor to create specific logic circuits.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

1. A computer-based information search method comprising:
receiving at least a search query, said search query comprising at least one term;
receiving a network resource list, said list comprising at least one web site selected from a predetermined web site list;
semantically analyzing said search query; and
searching said network resource list for a response to said search query using a search engine.

2. The computer-based information search method of claim 1, wherein said search query comprises at least one sentence.

3. The computer-based information search method of claim 1, wherein said search query comprises at least one paragraph having at least two sentences.

4. The computer-based information search method of claim 1, further comprising:
receiving at least one search query, said search query being conducted by said search engine at a pre-scheduled time.

5. The computer-based information search method of claim 1, wherein said predetermined web site list is categorized by technologies.

6. The computer-based information search method of claim 1, further comprising:
translating said search query into at least one language used by said search engine, said at least one language being different from a language in which said search query is written.

7. The computer-based information search method of claim 1, further comprising:
receiving search results from a search engine; and
prioritizing the search result by an attribute selected by a user.

8. The computer-based information search method of claim 1, further comprising:
receiving search results from a search engine; and
producing a summary report of at least one item of said search result selected by a user.

9. A computer-implemented system for information search, comprising:
means for receiving at least a search query, said search query comprising at least one term;
means for receiving a network resource list, said list comprising at least one web site selected from a predetermined web site list;
means for semantically analyzing said search query; and
means for searching said network resource list for a response to said search query using a search engine.

10. The system of claim 9, wherein said search query comprises at least one paragraph having at least two sentences.

11. The system of claim 9, wherein said search query is conducted by said search engine at a pre-scheduled time.

12. The system of claim 9, wherein said predetermined web site list is categorized by technologies.

13. The system of claim 9, further comprising:
means for translating said search query into at least one language used by said search engine, said at least one language being different from a language in which said search query is written.

14. A computer readable medium with computer program code, wherein, when the computer program code is executed by a processor, the processor performs a method of information search, comprising the steps of:
receiving at least a search query, said search query comprising at least one term;
receiving a network resource list, said list comprising at least one web site selected from a predetermined web site list;
semantically analyzing said search query; and
searching said network resource list for a response to said search query using a search engine.

15. The computer readable medium of claim 14, wherein said search query comprises at least one paragraph having at least two sentences.

16. The computer readable medium of claim 14, wherein said search query is conducted by said search engine at a pre-scheduled time.

17. The computer readable medium of claim 14, wherein said predetermined web site list is categorized by technologies.

18. The computer readable medium of claim 14, wherein the method further comprises translating said search query into at least one language used by said search engine, said at least one language being different from a language in which said search query is written.

19. A computer-based citation search method comprising:
receiving a search query, said search query comprising at least one patent identification condition;
receiving a list of one or more patent databases;
searching said list of patent databases to collect at least one first tier reference patent that cites or is cited by patents satisfying said condition of said search query; and
producing a citation list, said citation list identifying at least an owner of said first tier reference patent.

20. The computer-based citation search method of claim 19, wherein said patent identification condition is that patents found by said query are owned by an employer of a user.

21. The computer-based citation search method of claim 19, further comprising:
translating information used for producing said citation list of said reference patent.

22. The computer-based citation search method of claim 19, further comprising:
generating a notice to a predetermined person when said owner of said first tier reference patent matches a predetermined entity.

23. The computer-based citation search method of claim 19, wherein said search query contains a name of an entity, the method further comprising:
automatically using at least one additional name for searching, said at least one additional name associated with said name of said entity.

24. The computer-based citation search method of claim 23, wherein said at least one additional name is obtained by referring to an entity names table, said table containing at least one additional name of said entity.

25. The computer-based citation search method of claim 19, wherein the citation list identifies two patents as being commonly owned by a single entity, wherein each of the two patents specifies a different name of assignee.

26. The computer-based citation search method of claim 25, further comprising:
referring to an entity names table to identify two patents that specify different names of assignee as being commonly owned by said single entity, said table containing at least one additional name of said entity.

27. The computer-based citation search method of claim 19, wherein said first tier reference patent cites patents satisfying said condition of said search query, further comprising:
searching said list of patent databases to collect at least one second tier reference patent that cites said first tier reference patent; and
producing a second tier citation list, said citation list identifying at least an owner of said second tier reference patent.

28. The computer-based citation search method of claim 19, wherein said first tier reference patent is cited by patents satisfying said condition of said search query, further comprising:
searching said list of patent databases to collect at least one second tier reference patent that is cited by said first tier reference patent; and
producing a second tier citation list, said citation list identifying at least an owner of said second tier reference patent.

29. A computer-based citation search method comprising:
receiving a search query, said search query comprising at least one patent identification condition;
receiving a watch list, said watch list identifying at least one entity;
receiving a list of one or more patent databases;
searching said list of patent databases to collect target patents satisfying said condition set forth in said search query and whose owners match at least one said entity identified in said watch list;
searching said list of patent databases to collect reference patents that are cited by target patents; and
generating a notice to a predetermined person when an owner of said reference patent matches a predetermined entity.

30. A computer-implemented system for citation search comprising:
means for receiving a search query, said search query comprising at least one patent identification condition;
means for receiving a list of one or more patent databases;
means for searching said list of patent databases to collect at least one first tier reference patent that cites or is cited by patents satisfying said condition of said search query; and
means for producing a citation list, said citation list identifying at least an owner of said first tier reference patent.

31. The system of claim 30, further comprising:
means for generating a notice to a predetermined person when said owner of said first tier reference patent matches a predetermined entity.

32. The system of claim 30, wherein said search query contains a name of an entity, the system further comprising:
means for automatically using at least one additional name for searching, said at least one additional name associated with said name of said entity.

33. The system of claim 30, wherein the citation list identifies two patents as being commonly owned by a single entity, wherein each of the two patents specifies a different name of assignee.

34. A computer-implemented system for citation search comprising:
means for receiving a search query, said search query comprising at least one patent identification condition;
means for receiving a watch list, said watch list identifying at least one entity;
means for receiving a list of one or more patent databases;
means for searching said list of patent databases to collect target patents satisfying said condition set forth in said search query and whose owners match at least one said entity identified in said watch list;
means for searching said list of patent databases to collect reference patents that are cited by target patents; and
means for generating a notice to a predetermined person when an owner of said reference patent matches a predetermined entity.

35. A computer readable medium with computer program code, wherein, when the computer program code is executed by a processor, the processor performs a method of citation search, comprising the steps of:
receiving a search query, said search query comprising at least one patent identification condition;
receiving a list of one or more patent databases;
searching said list of patent databases to collect at least one first tier reference patent that cites or is cited by patents satisfying said condition of said search query; and
producing a citation list, said citation list identifying at least an owner of said first tier reference patent.

36. The computer readable medium of claim 35, the method further comprising:
generating a notice to a predetermined person when said owner of said first tier reference patent matches a predetermined entity.

37. The computer readable medium of claim 35, wherein said search query contains a name of an entity, the method further comprising:
automatically using at least one additional name for searching, said at least one additional name associated with said name of said entity.

38. The computer readable medium of claim 35, wherein the citation list identifies two patents as being commonly owned by a single entity, wherein each of the two patents specifies a different name of assignee.

39. A computer readable medium with computer program code, wherein, when the computer program code is executed by a processor, the processor performs a method of citation search, comprising the steps of:
receiving a search query, said search query comprising at least one patent identification condition;
receiving a watch list, said watch list identifying at least one entity;
receiving a list of one or more patent databases;
searching said list of patent databases to collect target patents satisfying said condition set forth in said search query and whose owners match at least one said entity identified in said watch list;
searching said list of patent databases to collect reference patents that are cited by target patents; and
generating a notice to a predetermined person when an owner of said reference patent matches a predetermined entity.
